(19) United States
(12) Patent Application Publication
(10) Pub. No.: US 2022/0065982 A1
(43) Pub. Date: Mar. 3, 2022

(54) TRAFFIC MANAGEMENT SYSTEM AND AN UNMANNED AERIAL VEHICLE COMPATIBLE WITH SUCH A SYSTEM

(71) Applicant: SAAB AB, Linköping (SE)

(72) Inventor: Lars JERNBÄCKER, Växjö (SE)

(21) Appl. No.: 17/286,170

(22) PCT Filed: Oct. 11, 2019
(86) PCT No.: PCT/SE2019/050999

§ 371 Date: Apr. 16, 2021

(30) Foreign Application Priority Data
Oct. 18, 2018 (SE) 1851285-5

(51) Int. Cl. G01S 7/00; G08G 5/00; G01S 13/91; G01S 13/72

(52) U.S. Cl. CPC G01S 7/006; G08G 5/0013; B64C 2201/141; G01S 13/726; G08G 5/0069; G01S 13/91

(57) ABSTRACT

The present invention relates to a traffic management system, a traffic management method, a computer program product, and an unmanned aerial vehicle compatible with such a system. The traffic management system comprises a millimetre wave base station having a communication mode and a radar mode, and operating in a first frequency range of 0.6 GHz-6 GHz and a second frequency range of 24 GHz-86 GHz. The system further has a control unit configured to operate the base station in the radar mode and the communication mode.

### TECHNICAL FIELD OF THE INVENTION

The present invention relates to a traffic management system, a corresponding method and an Unmanned Aerial Vehicle (UAV) compatible with such a system and method. Although the invention will mainly be described with respect to air traffic control, the invention is not restricted to this particular use but may also be used with other types of surface vehicles (e.g. cars, busses, trucks, etc.).

### BACKGROUND OF THE INVENTION

Vehicle traffic control has witnessed little advancement since its introduction in the 1920's. However, certain attempts have been made to implement more automated traffic control systems.

Moreover, Unmanned Aerial Vehicles (UAVs) or remote-piloted vehicles are appearing in the sky in exponentially increasing numbers. Autonomous Aerial Vehicles (AAVs) will soon be joining them which do not require remote piloting. With registration of these craft now mandatory in some countries, a safe and effective means of Air Traffic Control (ATC), enforcement of registration laws, and safety for both the public and the aerial vehicles is desired. The ATC can then provide that information to other agencies for threat assessment, air traffic warning and viewing systems, and the distributed air traffic monitoring systems.

Thus, with the increasing traffic density in the air as well as on the road, there is a need for solutions which allow for precise and reliable monitoring and tracking of vehicles over large areas. In particular when considering the increasing efforts in all fields of technology related to autonomous vehicles (both air and road), there is a need for new and improved traffic management systems and traffic management methods in the art, which account for the exponential increase in traffic that is to come in the near future.

Improved traffic monitoring and control and implementation of a state-of-the-art traffic management and control system could reduce traffic accidents and traffic-related deaths and improve traffic management.

### SUMMARY OF THE INVENTION

It is therefore an object of the present invention to provide a traffic management system, a traffic management method, a computer program product, and a UAV compatible with such a system, which is more suitable for growing autonomous vehicle fleets and can provide coverage over large areas in a cost-effective manner.

This object is achieved by means of a traffic management system, a method, and a computer program product as defined in the appended claims. The term exemplary is in the present context to be understood as serving as an instance, example or illustration.

According to a first aspect of the present invention, there is provided a traffic management system for traffic control, comprising:

a millimetre wave base station for a wireless communication system operating in a first frequency range of 0.6 GHz-6 GHz and a second frequency range of 24 GHz-86 GHz, the millimetre wave base station having a communication mode and a radar mode;

a control unit connected to the millimetre wave base station, the control unit being configured to:
operate the millimetre wave base station in the radar mode so to:
   transmit electromagnetic waves towards at least one target in a surrounding environment of the millimetre wave base station;
   receive electromagnetic waves from the surrounding environment;
   process the received electromagnetic waves through a matched filter in order to determine if the received electromagnetic waves are transmitted electromagnetic waves which have been reflected off the at least one target; and
   if the received electromagnetic waves are the transmitted electromagnetic waves which have been reflected off the target, compute a position of each target relative to the millimetre wave base station;
operate the millimetre wave base station in the communication mode so to:
   transmit a communication signal, from the at least one millimetre wave base station, towards at least one receiver, said communication signal comprising information about the position of each target.

The presented system enables a broadly distributed traffic management system capable of very accurately detecting and tracking vehicles by utilizing a cellular network infrastructure. More specifically, the system utilizes 5G (fifth generation of cellular mobile communications) base stations to operate as a distributed radar network with data communication capability.

The term “connected to” is in the present context to be interpreted broadly and may for example be understood as “operatively connected”, i.e. directly or indirectly connected. The control unit can be provided by means of appropriate software, hardware or a combination thereof. Moreover, the communication signal may be transmitted wirelessly by antenna elements of the millimetre wave base station, or through a wired connection from the millimetre wave base station to an external unit which in turn is part of a larger network.

The present invention is at least partly based on the realization that the upcoming 5G infrastructure will present new and unprecedented possibilities for managing air and/or surface traffic. Not only from an increased bandwidth perspective for data communication, but due to the fact that the same cellular base stations can be used as radar towers, which, for avionic applications, enables for a type of distributed surveillance radar, particularly suitable for urban UAV traffic. Further, it was realized that the millimetre wave frequency band (24 GHz to 86 GHz in the present context) which is envisioned for the 5G system, is particularly suitable for detecting and tracking smaller objects in the surrounding area of the base stations that are more or less invisible for the longer microwave wavelengths.

Moreover, the system is not only advantageous from a traffic management perspective, but also for aiding localization systems of the surface vehicles and UAVs by increasing the redundancy of these localization systems. In more detail, by suitable coordinate transformations (as will be exemplified in the following) the traffic management system can be used to provide a real-time map of a covered area including any vehicles/aircrafts operating in that area. This information may accordingly be used by a central entity or transmitted to the vehicle's themselves as an additional source of information.

In accordance with an exemplary embodiment of the present invention, the traffic management system further comprises a user interface connected to the control unit, and wherein the control unit is further configured to display a position of the target on the user interface. The user interface may for example be a display unit configured to plot the surrounding area of the millimetre wave base station and the detected targets. In other words, to provide an operator/user with a map which can be updated with real-time traffic information.

Further, in accordance with another exemplary embodiment of the present invention, the control unit is further configured to compute a velocity and/or acceleration of each target relative to the millimetre wave base station. By including velocity and/or acceleration as an output parameter from the radar measurement, it is possible to make predictions of trajectories or future positions of each target, which may be advantageous for properly managing traffic.

According to another exemplary embodiment of the present invention, each millimetre wave base station has a predefined geographical position, and wherein the control unit is further configured to:

determine a geographical position of each target based on the positon of each target relative to the millimetre base station and the geographical position of the millimetre wave base station; and

wherein the communication signal further comprises information about the determined geographical position of each target. In other words, the control unit performs a coordinate transformation from a local coordinate system of the millimetre wave base station to a global coordinate system. The geographical position (i.e. position in a global coordinate system) can then be transmitted to a central entity or to associated vehicles/aircrafts. In reference to the latter, by performing the coordinate transformation locally at the base station prior to sending the positions, the information may be applied directly in the vehicle/aircraft and a broadcasting function may be used by the millimetre wave base station. Moreover, the need for increased processing power in each vehicle is mitigated.

Furthermore, the control unit can also be configured to predict a trajectory and/or a future position of the target based on the computed (current) position and the velocity of the target. Velocity is in the present context to be construed as the speed of something in a given direction.

Even further, in accordance with yet another exemplary embodiment of the present invention, the traffic management system further comprises a system controller connected to the control unit of the millimetre wave base station, wherein each millimetre wave base station has a predefined geographical position and wherein the system controller is configured to:

receive the communication signal from each millimetre wave base station;

determine a geographical position of each target based on the information about the position of each target and the geographical position of each millimetre wave base station.

In other words, the system has a type of a central controller arranged to transform the received target positions from a local coordinate system of each base station to a global coordinate system. This information may subsequently be distributed to each target (e.g. road vehicle, airplane, UAV, etc.) whereby each vehicle can be aware of the position of surrounding vehicles in a common (global) coordinate system. Similar to the previous embodiment of the invention, the system controller may be configured to determine a trajectory and/or future position of the target(s).

In accordance with another aspect of the present invention, there is provided a traffic management method for a wireless communication system comprising at least one millimetre wave base station, the wireless communication system operating in a first frequency range of 0.6 GHz-6 GHz and a second frequency range of 24 GHz-86 GHz, the at least one millimetre wave base station having a communication mode and a radar mode, the traffic management method comprising: 0.6 operating the at least one millimetre wave base station in the radar mode so to:
emit a radar waveform, from the at least one millimetre wave base station, towards at least one target in a surrounding environment of the millimetre wave base station;
receive electromagnetic waves, with the at least one millimetre wave base station;
identify a reflected radar waveform in the received electromagnetic waves;
determine a position of each target from the reflected radar waveform, relative to the millimetre wave base station;

operating the at least one millimetre wave base station in the communication mode so to:
emit a communication signal, from the at least one millimetre wave base station, towards at least one receiver in a surrounding environment of the millimetre wave base station, the communication signal comprising information about the position of each target.

With this aspect of the invention, similar advantages and preferred features are present as in the previously discussed aspect of the invention, and vice versa.

Accordingly, in one exemplary embodiment of the present invention, the method further comprises a step of determining a velocity of each target while in the radar mode. The velocity parameter may be used to derive an acceleration of each target, and to predict trajectories and/or future positions.

Furthermore, in accordance with another exemplary embodiment of the present invention, the millimetre wave base station has a predefined geographical position, and wherein the method further comprises transforming the determined position of each target from a local coordinate system to a global coordinate system based on the geographical position of the millimetre wave base station(s).

Moreover, in accordance with another aspect of the present invention, there is provided a non-transitory computer-readable storage medium storing one or more programs configured to be executed by one or more processors of a vehicle control system, the one or more programs comprising instructions for performing the method according to any one of the embodiments discussed in reference to the second aspect of the present invention. With this aspect of the invention, similar advantages and preferred features are present as in the previously discussed aspects of the invention.

Yet further, in accordance with another aspect of the present invention, there is provided an unmanned aerial vehicle (UAV), comprising:

a receiver for receiving wireless data packets from a millimetre wave base station operating in a first frequency range of 0.6 GHz-6 GHz and a second frequency range of 24 GHz-86 GHz of a traffic management system according to any one of the embodiments discussed in reference to the first aspect of the present invention;

a localization system for estimating a geographical position of the UAV;

a controller configured to:
retrieve the wireless data packets received by the receiver, said wireless data packets comprising base station radar data and a geographical position of the millimetre wave base station, wherein the base station radar data comprises information about the position, relative to the millimetre wave base station, of each target in a surrounding environment of the millimetre wave base station,
determine a geographical position of each target based on the retrieved position of each target relative to the millimetre wave base station and the geographical position of the millimetre wave base station;
identify the UAV in the base station radar data, based on the determined geographical position of each target and the estimated geographical position of the UAV;
determine a position of the UAV relative to the millimetre wave base station after the UAV has been identified in the base station radar data;

determine a position of each target relative to the UAV, based on the determined position of the UAV relative to the millimetre wave base station, and the base station radar data.

With this aspect of the invention, similar advantages and preferred features are present as in the previously discussed aspects of the invention.

These and other features and advantages of the present invention will in the following be further clarified with reference to the embodiments described hereinafter.

### BRIEF DESCRIPTION OF THE DRAWINGS

For exemplifying purposes, the invention will be described in closer detail in the following with reference to embodiments thereof illustrated in the attached drawings, wherein:

FIG. 1 is a perspective view illustration of a traffic management system for traffic control in accordance with an embodiment of the present invention;

FIG. 2 is a perspective view illustration of a traffic management system for traffic control in accordance with an embodiment of the present invention;

FIG. 3 is a schematic flowchart representation of a traffic management method in accordance with an embodiment of the present invention;

FIG. 4 is a schematic illustration of an unmanned aerial vehicle (UAV) in accordance with an embodiment of the present invention.

### DETAILED DESCRIPTION

In the following detailed description, preferred embodiments of the present invention will be described. However, it is to be understood that features of the different embodiments are exchangeable between the embodiments and may be combined in different ways, unless anything else is specifically indicated. Even though in the following description, numerous specific details are set forth to provide a more thorough understanding of the present invention, it will be apparent to one skilled in the art that the present invention may be practiced without these specific details. In other instances, well known constructions or functions are not described in detail, so as not to obscure the present invention.

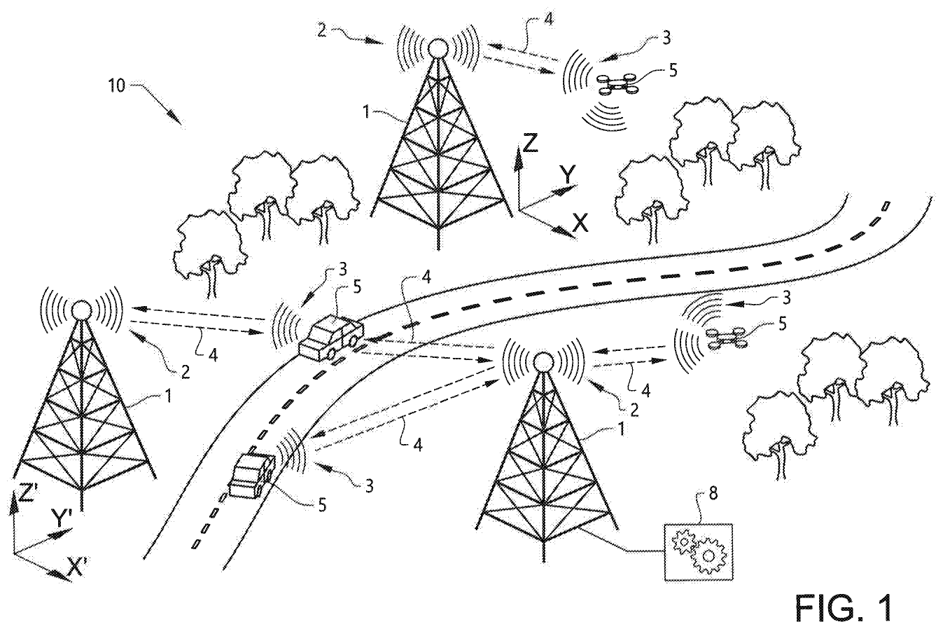

FIG. 1 is a schematic illustration of a traffic management system 10 according to an embodiment of the present invention. The system 10 includes a plurality of millimetre wave base stations 1 suitable for a wireless communication system (such as e.g. a cellular network). Examples of cellular radio technologies are LTE, 5G, 5G NR, and so on, also including future cellular solutions.

However, the millimetre wave base stations 1 are particularly suitable for a wireless communication system operating in two frequency ranges, a first frequency range between 0.6 GHz and 6 GHz, and a second frequency range between 24 GHz and 89 GHz. Moreover, each millimetre wave base station 1 has a communication mode and a radar mode. In other words, each millimetre wave base station 1 is arranged to be able to transmit and receive wireless data packets/communication signals, and transmit and receive radar waveforms. The millimetre wave base station have known and predefined geographical positions (e.g. Global Navigation Satellite System, GNSS, coordinates). Regional examples of GNSSs are e.g. Global Positioning System (GPS), Globalnaya Navigazionnaya Sputnikovaya Sistema (GLONASS), Galileo and Beidou.

Further, the traffic management system comprises one or more control units 8 connected to one or more millimetre wave base stations 1. In some embodiments, each millimetre wave base station may have one local control unit 8 each of which is configured to operate the base station 1 in both the communication mode and the radar mode. In other embodiments, two or more millimetre wave base stations 1 may share a common control unit (not shown). The millimetre wave base stations 1 may either support switching between the radar mode and the communication mode, or support simultaneous operation of communication and radar mode.

The control unit 8 is configured to operate the millimetre wave base station 1 in the radar mode so to transmit electromagnetic waves (radar output waveforms 2) towards one or more targets 5, and to receive electromagnetic waves from the surrounding environment Furthermore, the control unit 8 is configured to process the received electromagnetic waves through one or more matched filters in order to determine if the received electromagnetic waves are transmitted electromagnetic waves which have been reflected 3 off the at least one target. Matched filters are commonly used in radar applications, where known signal 2 is sent out, and the reflected signal 3 is examined for common elements of the out-going signal.

Next, if it is determined that the received electromagnetic waves are the transmitted electromagnetic waves 2 which have been reflected 3 off the target 5, the control unit 8 is configured to compute a position of each target 5 relative to the millimetre wave base station. In other words, the control unit 8 determines a position of the target 5 in a local coordinate system (see references X, Y, Z and X′, Y′, Z′ in FIG. 1 indicating two separate local coordinate systems). Moreover, the control unit 8 may further compute a velocity and acceleration of each target 5 relative to the millimetre wave base station 1.

The control unit 8 may also be configured to determine a geographical position of each target 5 (i.e. a map position) by transforming each target's 5 position form the local coordinate system to a global coordinate system, so that the targets 5 may be tracked on a map. The transformation can be done by using map data (e.g. from HD maps) together with the known (predefined) geographical position of the millimetre wave base station 1 and the position of each target 5 relative to the millimetre wave base station 1.

Further, the control unit 8 is configured to operate the millimetre wave base station 1 in the communication mode so to transmit a communication signal 4. The communication signal 4 accordingly contains information about the position of each detected target 5. The communication signal may for example be transmitted to receivers arranged in the targets 5, i.e. in vehicles/such as UAVs, cars, busses, trucks, etc.), to other base stations, or remote servers. The communication signal may be transmitted via wired connection, a wireless connection, or a combination thereof. The vehicles may then utilize the positional data in a localization system, which may be particularly advantageous to increase redundancy in autonomous/semi-autonomous driving or flying applications.

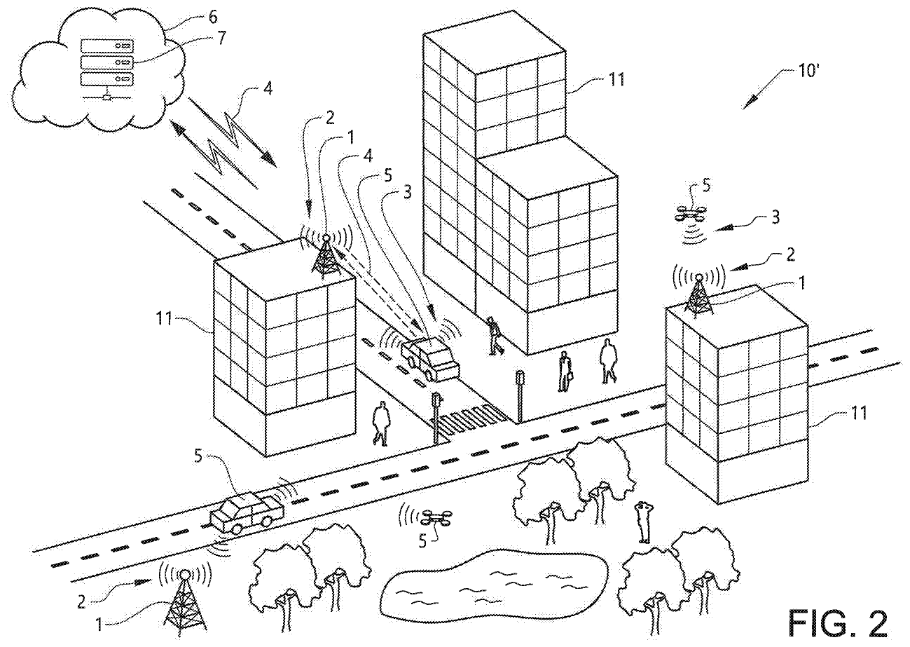

FIG. 2 shows a schematic illustration of a traffic management system 10′ in accordance with another embodiment of the present invention. Here, the traffic management system 10′ is for the most part similar to the system described with reference to FIG. 1, wherefore the same elements as already discussed in the foregoing will not be further discussed.

In the embodiment illustrated in FIG. 1, the traffic management system further has a system controller 7 connected to the control unit of each base station 1. The system controller 7 may be part of a central entity 6 managing larger area having a plurality of millimetre wave base stations 1 and their associated control units. The system controller 7 may be configured to receive the communication signal 4 from each millimetre wave base station 1 and determine a geographical position of each target 5 based on the received communication signal (which contains positional data) and the geographical position of each millimetre wave base station. Accordingly, each millimetre wave base station 1 transmits “raw” positional data containing information about the position of each target 5 relative to each base station, so that any subsequent coordinate transformation is done centrally by the system controller 7. Hereby it may be possible to compute the position of a target based on radar measurements from different base stations, which may increase the accuracy of the subsequent geographical positioning determining process.

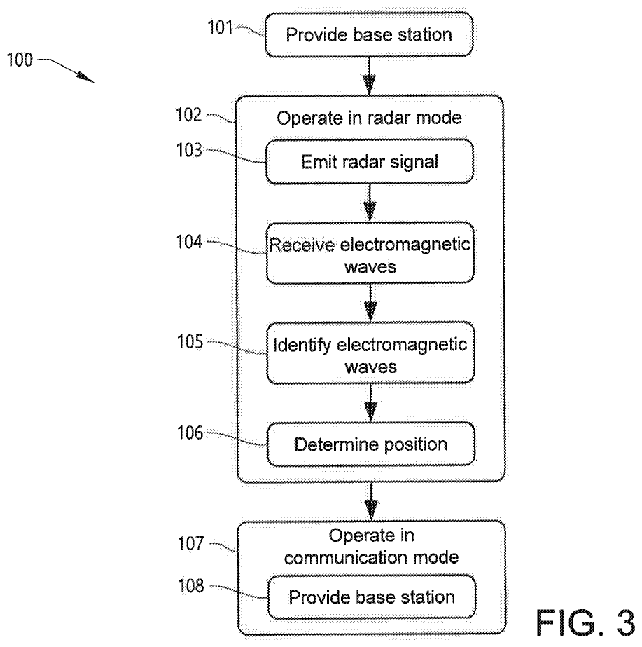

FIG. 3 is a flow chart representation of a traffic management method 100 including the step of providing a millimetre wave base station for a wireless communication system operating in a first frequency range of 0.6 GHz-6 GHz and a second frequency range of 24 GHz-86 GHz. The millimetre wave base station has a communication mode and a radar mode.

The method 100 further comprises operating 102 the millimetre wave base station in the radar mode so to emit 103 a radar waveform towards one or more targets in a surrounding environment of the millimetre wave base station. Moreover, the method 100 includes receiving 103 electromagnetic waves, identifying 104 a reflected radar waveform in the received electromagnetic waves and determining 105 a position of each target from the reflected radar waveform. Next, the millimetre wave base station is operated 107 in the communication mode so to emit 108 a communication signal (different from the radar signal waveform) including information about the position of each target.

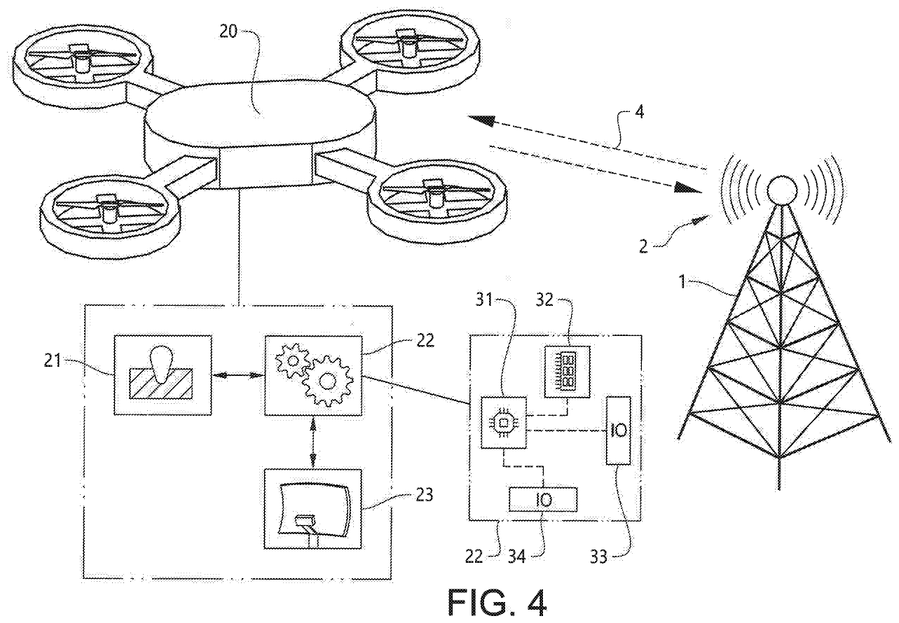

FIG. 4 is a schematic illustration of an unmanned aerial vehicle (UAV) 20 in accordance with an embodiment of the present invention. The UAV 20 is here in the form of a quadcopter drone. The UAV comprises a receiver 23 for receiving wireless data packets from a millimetre wave base station operating in a first frequency range of 0.6 GHz-6 GHz and a second frequency range of 24 GHz-86 GHz of a traffic management system (i.e. a system as discussed in the foregoing with reference to FIG. 1 and FIG. 2). Moreover, the UAV has a localization system 21 (e.g. a Global Navigation Satellite System (GNSS) unit), and a controller 22.

Here, the controller 22 is configured to retrieve the wireless data packets received by the receiver 23 from the millimetre wave base station. The wireless data packets comprise base station radar data and a geographical position of the millimetre wave base station, where the base station radar data includes information about the position, relative to the base station, of each target in a surrounding environment of the millimetre wave base station. In other words, the radar data comprises information about the position of each target in a local coordinate system of each millimetre wave base station.

Moreover, the controller 22 is further configured to determine a geographical position (i.e. a position in a global coordinate system) of each target based on the retrieved position of each target and the geographical position of the millimetre wave base station. Stated differently, the controller 22 is further configured to transform the position of each target from the local coordinate system of the millimetre wave base station to a global coordinate system (e.g. GNSS coordinates).

Further, the controller 22 identifies the UAV in the base station radar data, based on the determined geographical position and the estimated geographical position of the UAV. In more detail, this step can be understood as that the controller forms a map of all the identified targets and then finds itself among the targets. This can either be done by comparing the geographical position of each target with the UAV's estimated GNSS position (if the localization system comprises a GNSS unit), and/or by using one or more external sensors of the UAV arranged to identify targets in the surrounding environment of the UAV, and compare this information with the distribution of targets on the map. The external sensors may for example be one or more of a radar arrangement, a LIDAR system, cameras, etc.

Next, the controller 22 determines the position of the UAV relative to the millimetre wave base station from the base station radar data. The accuracy of this measurement is greater than with conventional technology such as e.g. GNSS. Now, that the controller knows which one of the targets that is the UAV in the base station radar data, and accordingly its own position relative to the millimetre wave base station, it is possible to transform all target positions from the coordinate system of the base station, to a local coordinate system of the UAV, in other words, the UAV can use the millimetre wave base station radar as an additional input to its own localization system, increasing the robustness and redundancy of the same.

Each controller 7, 8, 22 described in the foregoing may for example be manifested as a general-purpose processor, an application specific processor, a circuit containing processing components, a group of distributed processing components, a group of distributed computers configured for processing, a field programmable gate array (FPGA), etc. Each controller 7, 8, 22 may further include a microprocessor, microcontroller, programmable digital signal processor or another programmable device. Each controller 7, 8, 22 may also, or instead, include an application-specific integrated circuit (ASIC), a programmable gate array or programmable array logic, a programmable logic device, or a digital signal processor. Where the controller 7, 8, 22 includes a programmable device such as the microprocessor, microcontroller or programmable digital signal processor mentioned above, the processor may further include computer executable code that controls operation of the programmable device.

It should be understood that the controllers 7, 8, 22 may comprise a digital signal processor arranged and configured for digital communication with an off-site server or cloud based server. Thus data may be sent to and from the controllers 7, 8, 22, as readily understood by the skilled reader.

Further, it should be understood that parts of the described solution may be implemented either in the controller 7, 8, 22, in a system 6 located external the controller, or in a combination of internal and external the controller 7, 8, 22; for instance in a server 7 in communication with the controller 7, 8, 22, a so called cloud solution. For instance, communication signal may be sent to an external system 6 and that external system 6 performs the steps to determine the predicted position of the target 5 and send back information indicating the predicted position and other relevant parameters used in tracking the target 5.

The processor 31 (of the controllers 7, 8, 22) may be or include any number of hardware components for conducting data or signal processing or for executing computer code stored in memory. The controllers 7, 8, 22 may have an associated memory 32, and the memory 32 may be one or more devices for storing data and/or computer code for completing or facilitating the various methods described in the present description. The memory 32 may include volatile memory or non-volatile memory. The memory 32 may include database components, object code components, script components, or any other type of information structure for supporting the various activities of the present description. According to an exemplary embodiment, any distributed or local memory device may be utilized with the systems and methods of this description. According to an exemplary embodiment the memory 32 is communicably connected to the processor 31 (e.g., via a circuit or any other wired, wireless, or network connection) and includes computer code for executing one or more processes described herein.

Moreover, depending on functionality provided in the control circuitry one or more communication interfaces 33, 34 and/or one or more antenna interfaces (not shown) may be provided and furthermore, also one or more sensor interfaces (not shown) may be provided for acquiring data from sensors within the UAV 20. Even though, a detailed example of a controller is only illustrated with respect to control unit 22, it is readily understood by the skilled reader that the same general structure is applicable on the controllers 7, 8 discussed in reference to FIGS. 1 and 2.

In summary, the proposed invention contemplates that the upcoming 5G infrastructure will present new and unprecedented possibilities for managing air and/or surface traffic. Not only from an increased bandwidth perspective for data communication, but due to the fact that the same cellular base stations can be used as radar towers, which, for avionic applications, enables for a type of distributed surveillance radar, particularly suitable for urban UAV traffic. Further, the millimetre wave frequency band (24 GHz to 86 GHz in the present context) which is envisioned for the 5G system, may be particularly suitable for detecting and tracking smaller objects in the surrounding area of the base stations that are more or less invisible for the longer microwave wavelengths.

Moreover, the system is not only advantageous from a traffic management perspective, but also for aiding localization systems of the UAVs/vehicles by increasing the redundancy of these localization systems. In more detail, by suitable coordinate transformations (as will be exemplified in the following) the traffic management system can be used to provide a real-time map of a covered area including any vehicles/aircrafts operating in that area. This information may accordingly be used by a central entity or transmitted to the vehicle's themselves as an additional source of information.

The present disclosure contemplates methods, devices and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor.

By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data that cause a general-purpose computer, special purpose computer, or special purpose processing machines to perform a certain function or group of functions. As already exemplified, some parts or all of the functions may be realized as a “cloud-based” solution.

Although the figures may show a specific order of method steps, the order of the steps may differ from what is depicted. In addition, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps. Additionally, even though the disclosure has been described with reference to specific exemplifying embodiments thereof, many different alterations, modifications and the like will become apparent for those skilled in the art.

It is to be understood that the present invention is not limited to the embodiments described above and illustrated in the drawings; rather, the skilled person will recognize that many changes and modifications may be made within the scope of the appended claims. Thus, variations to the disclosed embodiments can be understood and effected by the skilled addressee in practicing the claimed disclosure, from a study of the drawings, the disclosure, and the appended claims. Furthermore, in the claims, the word “comprising” does not exclude other elements or steps, and the indefinite article “a” or “an” does not exclude a plurality.

1. A traffic management system for traffic control, the traffic management system comprising:
a millimetre wave base station for a wireless communication system operating in a first frequency range of 0.6 GHz-6 GHz and a second frequency range of 24 GHz-86 GHz, the millimetre wave base station having a communication mode and a radar mode;
a control unit connected to the millimetre wave base station, the control unit configured to:
operate the millimetre wave base station in the radar mode configured to:
transmit electromagnetic waves towards at least one target in a surrounding environment of the millimetre wave base station;
receive electromagnetic waves from the surrounding environment;
process the received electromagnetic waves through a matched filter in order to determine if the received electromagnetic waves are transmitted electromagnetic waves from the millimetre wave base station which have been reflected off the at least one target;
if the received electromagnetic waves are the transmitted electromagnetic waves which have been reflected off the target, compute a position of each target relative to the millimetre wave base station; and
operate the millimetre wave base station in the communication mode so to:
transmit a communication signal, from the at least one millimetre wave base station, towards at least one receiver, said communication signal comprising information about the position of each target.

2. The traffic management system according to claim 1, further comprising a user interface connected to the control unit, wherein the control unit is further configured to display a position of the target on the user interface.

3. The traffic management system according to claim 1 wherein the control unit is further configured to compute a velocity of each target relative to the millimetre wave base station.

4. The traffic management system according to claim 3, wherein the control unit is further configured to compute an acceleration of each target relative to the millimetre wave base station.

5. The traffic management system according to claim 1, wherein each millimetre wave base station has a predefined geographical position, and wherein the control unit is further configured to:
determine a geographical position of each target based on the position of each target relative to the millimetre base station and the geographical position of the millimetre wave base station; and
wherein the communication signal further comprises information about the determined geographical position of each target.

6. The traffic management system according to claim 1, further comprising a system controller connected to the control unit of the millimetre wave base station, wherein each millimetre wave base station has a predefined geographical position and wherein the system controller is configured to:
receive the communication signal from each millimetre wave base station; and
determine a geographical position of each target based on the information about the position of each target and the geographical position of each millimetre wave base station.

7. The traffic management system according to claim 1, wherein the communication signal further comprises information about the velocity of each target relative to the millimetre wave base station.

8. The traffic management system according to claim 1, comprising a plurality of millimetre wave base stations.

9. A traffic management method for a wireless communication system comprising at least one millimetre wave base station, the wireless communication system operating in a first frequency range of 0.6 GHz-6 GHz and a second frequency range of 24 GHz-86 GHz, the at least one millimetre wave base station having a communication mode and a radar mode, the traffic management method comprising:
operating the at least one millimetre wave base station in the radar mode configured to:
emit a radar waveform, from the at least one millimetre wave base station, towards at least one target in a surrounding environment of the millimetre wave base station;
receive electromagnetic waves, with the at least one millimetre wave base station;
identify a reflected radar waveform in the received electromagnetic waves;
determine a position of each target from the reflected radar waveform, relative to the millimetre wave base station; and
operating the at least one millimetre wave base station in the communication mode so to:
emit a communication signal, from the at least one millimetre wave base station, towards at least one receiver in a surrounding environment of the millimetre wave base station, said communication signal comprising information about the position of each target.

10. A non-transitory computer-readable storage medium storing one or more instructions which, when executed by one or more processors of a traffic management system, the one or more instructions for performing the method according to claim 9.

11. An unmanned aerial vehicle (UAV), comprising:
a receiver for receiving wireless data packets from a millimetre wave base station operating in a first frequency range of 0.6 GHz-6 GHz and a second frequency range of 24 GHz-86 GHz of a traffic management system, the traffic management system comprising:
a millimetre wave base station for a wireless communication system operating in a first frequency range of 0.6 GHz-6 GHz and a second frequency range of 24 GHz-86 GHz, the millimetre wave base station having a communication mode and a radar mode;
a control unit connected to the millimetre wave base station, the control unit being configured to:
operate the millimetre wave base station in the radar mode configured to:
transmit electromagnetic waves towards at least one target in a surrounding environment of the millimetre wave base station;
receive electromagnetic waves from the surrounding environment;
process the received electromagnetic waves through a matched filter in order to determine if the received electromagnetic waves are transmitted electromagnetic waves from the millimetre wave base station which have been reflected off the at least one target;
if the received electromagnetic waves are the transmitted electromagnetic waves which have been reflected off the target, compute a position of each target relative to the millimetre wave base station; and
operate the millimetre wave base station in the communication mode so to:
transmit a communication signal, from the at least one millimetre wave base station, towards at least one receiver, said communication signal comprising information about the position of each target;
a localization system for estimating a geographical position of the UAV;
a controller configured to:
retrieve the wireless data packets received by the receiver, said wireless data packets comprising base station radar data and a geographical position of the millimetre wave base station, wherein the base station radar data comprises information about the position, relative to the millimetre wave base station, of each target in a surrounding environment of the millimetre wave base station,
determine a geographical position of each target based on the retrieved position of each target relative to the millimetre wave base station and the geographical position of the millimetre wave base station;
identify the UAV in the base station radar data, based on the determined geographical position of each target and the estimated geographical position of the UAV;
determine a position of the UAV relative to the millimetre wave base station after the UAV has been identified in the base station radar data; and
determine a position of each target relative to the UAV, based on the determined position of the UAV relative to the millimetre wave base station, and the base station radar data.
